(19) United States
(12) Patent Application Publication
(10) Pub. No.: US 2020/0086331 A1
(43) Pub. Date: Mar. 19, 2020

(54) Dust-proof computer display

(71) Applicant: Yudong Zhu, Wuhan City (CN)

(72) Inventor: Yudong Zhu, Wuhan City (CN)

(21) Appl. No.: 16/690,093

(22) Filed: Nov. 20, 2019

(30) Foreign Application Priority Data
Apr. 25, 2019 (CN) 2019103377430

(51) Int. Cl. B04C 5/185; G06F 1/16

(52) U.S. Cl. CPC B04C 5/185; G06F 1/1601

(57) ABSTRACT

A dust-proof computer display includes a display and a screen disposed on the display, the display has a bracket on a lower side thereof, a main cavity is disposed in the display, the main cavity is open to the front, and the main cavity is topped the wall is provided with an upper sliding slot; the invention has the advantages of simple structure and simple use. After the display is used, the invention can automatically wipe the screen to remove the dust on the screen, and after the wiping is completed, the screen is covered with a dust cloth. Enclosed to prevent image display distortion caused by dust accumulation when the display is not in use, greatly improving work efficiency.

### CROSS-REFERENCES TO RELATED APPLICATIONS

The present application claims priority from Chinese application No. 2019103377430 filed on Apr. 25, 2019 which is hereby incorporated by reference in its entirety.

### TECHNICAL FIELD

The present invention relates to the technical field of computer accessory, in particular to a dust-proof computer display.

### BACKGROUND OF THE INVENTION

Since the monitor generates static electricity when it works, the dust will also generate static electricity due to friction in the air. Therefore, the screen of the monitor is easily contaminated with dust when it is used. When the screen is not exposed, the screen of the monitor is exposed to the environment, and dust will gradually adhere to the screen. In the above, the resolution of the screen is affected, and the device is proposed in view of the above drawbacks.

### BRIEF SUMMARY OF THE INVENTION

In view of the deficiencies of the above techniques, the present invention proposes a dust-proof computer display that overcomes the above drawbacks.

The invention relates to a dust-proof computer display, comprising a display and a screen disposed on the display, the display is provided with a bracket on a lower side thereof, and the display is provided with a main cavity opening to the front, the top wall of the main cavity An upper sliding slot is disposed therein, and an upper protruding block is slidably disposed in the upper sliding slot, a bottom sliding wall is disposed on the bottom wall of the main cavity, and a guiding block is slidably disposed in the sliding groove, and the upper end surface of the guiding block is disposed a guiding groove, the bottom wall of the main cavity is provided with a through groove communicating with the guiding groove, a sliding protrusion is arranged in the guiding groove, and the lower protruding block and the left end surface of the guiding groove Connected by a return spring, a screw rod is disposed between the left and right walls of the sliding groove, the screw rod penetrates the guiding block and is threadedly engaged with the guiding block, and the lower end surface of the upper protruding block and the lower portion A fixing rod is fixedly disposed between the upper end surface of the protruding block, and the dust removing plate is fixedly disposed on the fixing rod, and the rear end surface of the dust removing plate is fixedly provided with a wiping portion, wherein the wiping portion is an elastic material, and the upper sliding slot is Sliding is provided with an active plate that abuts the rear end surface of the upper protruding block, when the display After the end, the active plate moves forwardly through the upper protruding block, the fixing rod drives the dust removing plate to protrude forwardly outside the front end opening of the main cavity, and the rear end surface of the wiping portion On the rear side of the front end surface of the screen, the screw rotates to drive the guiding block to perform translation, and the wiping portion can be fully adhered to the screen to remove dust when the elastic material reaches the screen position.

Preferably, the display is provided with a sub-cavity, the dust-removing plate is movable into the sub-cavity, and a rotating shaft is disposed between the upper and lower walls of the main cavity, and the rotating shaft is provided with a dust cloth. One end of the dustproof cloth is fixedly connected to the left end surface of the dust removing plate, and a torsion spring is connected between the rotating shaft and the top wall of the main cavity, and when the dust removing plate moves into the auxiliary cavity, The dust-proof shutter moves the screen to prevent dust.

Preferably, the rear wall of the main cavity is fixedly provided with an air pump, the front end of the air pump is provided with a cylinder, the front end of the cylinder is connected with the rear end surface of the active plate, and the motor is provided in the right wall of the sliding groove, the motor and the motor The lead screw is dynamically connected, the display is provided with a vertically symmetrical storage cavity, the intermediate cavity is slidably disposed in the storage cavity, and the lower end surface of the upper intermediate plate is connected with the active plate, and the upper and lower intermediate plates are connected The front end surface is symmetrically fixedly connected with a closing plate, and the closing plate on the left side closes the main cavity, and the closing plate on the right side closes the sub-cavity.

Preferably, the rear wall of the main chamber is provided with a liquid storage tank, the liquid storage tank is provided with a cleaning liquid chamber, and the inner wall of the cleaning liquid chamber is provided with a liquid filling valve, and the outer surface of the liquid storage tank is fixedly disposed. a nozzle communicating with the cleaning liquid chamber, wherein the cleaning liquid chamber is slidably provided with a pressing block, and a spring is connected between the rear end surface of the pressing block and the rear wall of the cleaning liquid chamber, and the cleaning liquid chamber is a cleaning liquid is disposed, the air pump is in communication with the cleaning liquid chamber through an intake pipe, and a check valve is disposed in the intake pipe. When the air pump is started, gas enters the extrusion block through the intake pipe. The side presses the pressing block forward to press the cleaning liquid in the cleaning liquid chamber to spray on the wiping portion through the nozzle, thereby achieving a better cleaning effect.

In summary, the present invention has a simple structure and is easy to use. After the display is used, the present invention can automatically wipe the screen to remove dust on the screen. After the wiping is completed, the screen is closed by a dust cloth. It prevents image display distortion caused by dust accumulation when the display is not in use, which greatly improves work efficiency.

### BRIEF DESCRIPTION OF THE DRAWINGS

The present invention will now be described in detail with reference to FIGS. 1-3. Here, for convenience of description, the orientations described below are defined as follows: the up, down, left, and right front and rear directions described below are identical to the up, down, left, and right front and rear directions of the projection relationship of FIG. 1 itself.

FIG. 1 is a schematic view showing the overall structure of a dust-proof computer display of the present invention;

FIG. 2 is a schematic view showing the structure of A-A in FIG. 1;

FIG. 3 is a schematic view showing the structure of B-B in FIG. 1.

### DETAILED DESCRIPTION OF THE INVENTION

The present invention will be further described with reference to the accompanying drawings and embodiments, which, however, are not limited to the following embodiments.

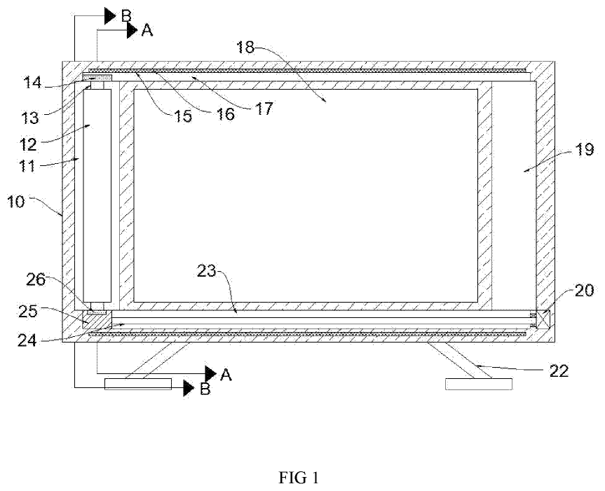

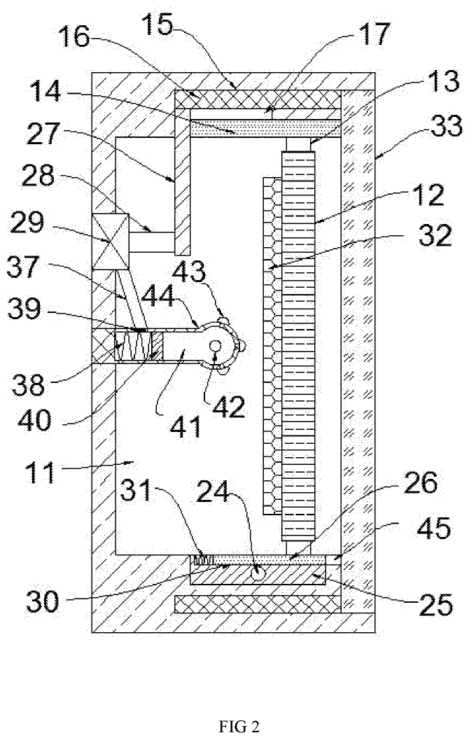

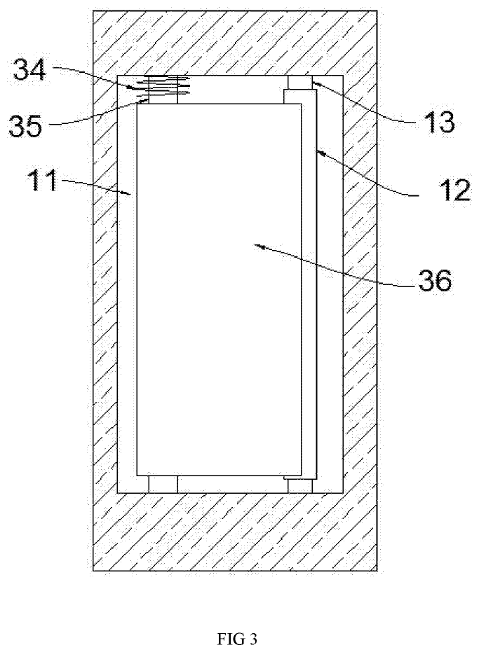

As shown in FIG. 1-3, a dust-proof computer display of the device of the present invention includes a display 10 and a screen 18 disposed on the display 10. The display 10 is provided with a bracket 22 on the lower side thereof. The main cavity 11 is provided with an opening, and the upper sliding slot 17 is disposed in the top wall of the main cavity 11. The upper sliding slot 17 is provided with an upper protruding block 14 and the bottom wall of the main cavity 11 is provided. a sliding groove 23, a guiding block 25 is disposed in the sliding groove 23, and a guiding groove 30 is disposed on the upper end surface of the guiding block 25. The bottom wall of the main cavity 11 is provided with a through groove communicating with the guiding groove 30. 45, a lower protruding block 26 is slidably disposed in the guiding groove 30, and the lower protruding block 26 is connected with the left end surface of the guiding groove 30 by a return spring 31, and the sliding groove 23 is rotated between the left and right walls. a screw rod 24 is disposed, the threaded rod 24 extends through the guide block 25 and is threadedly engaged with the guide block 25, and the lower end surface of the upper protruding block 14 and the upper end surface of the lower protruding block 26 are fixedly disposed. The fixing rod 13 is fixedly disposed with a dust removing plate 12, and the rear end surface of the dust removing plate 12 is fixedly provided with a wiping portion 32, and the wiping portion 32 is an elastic material. The upper sliding slot 17 is slidably provided with an active plate 27 that abuts the rear end surface of the upper protruding block 14. After the display is used, the active plate 27 moves forward through the upper protruding block 14. The fixing rod 13 drives the dust removing plate 12 to protrude forwardly from the front end opening of the main cavity 11, and the rear end surface of the wiping portion 32 is located at the rear side of the front end surface of the screen 18, the wire The rotation of the rod 24 causes the guiding block 25 to translate, and the wiping portion 32 can be fully adhered to the screen 18 for dust removal when the elastic material reaches the position of the screen 18.

Advantageously, the display 10 is provided with a sub-chamber 19, wherein the dust-removing plate 12 is movable into the sub-chamber 19, and a rotating shaft 35 is provided between the upper and lower walls of the main chamber 11, and the rotating shaft 35 is provided. A dust-proof cloth 36 is disposed on the upper end of the dust-removing plate 12, and a torsion spring 34 is connected between the rotating shaft 35 and the top wall of the main cavity 11. When the dust removing plate 12 moves into the sub-chamber 19, the dust cloth 36 is pulled to seal the screen 18 to prevent dust.

Advantageously, the rear wall of the main chamber 11 is fixedly provided with an air pump 29, the front end of the air pump 29 is provided with a cylinder 28, the front end of the cylinder 28 is connected with the rear end surface of the active plate 27, and the right side wall of the sliding groove 23 is provided. There is a motor 20, the motor 20 is dynamically connected to the lead screw 24, and the display 10 is provided with a vertically symmetrical storage cavity 15, and the intermediate cavity 16 is slidably disposed in the storage cavity 15, and the intermediate plate is on the upper side. The lower end surface of the 16 is connected to the active plate 27, and the front end surface of the upper and lower intermediate plates 16 is symmetrically fixedly connected with a closing plate 33, and the closing plate 33 on the left side closes the main cavity 11, and the closing plate on the right side 33 closes the sub-chamber 19.

Advantageously, the rear wall of the main chamber 11 is provided with a liquid storage tank 44. The liquid storage tank 44 is provided with a cleaning liquid chamber 41. The inner wall of the cleaning liquid chamber 41 is provided with a liquid filling valve 42 for the liquid storage. The outer surface of the box 44 is fixedly provided with a nozzle 43 communicating with the cleaning liquid chamber 41. The cleaning liquid chamber 41 is slidably provided with a pressing block 40, and the rear end surface of the pressing block 40 is behind the cleaning liquid chamber 41. A spring 38 is connected between the walls, and the cleaning liquid chamber 41 is provided with a cleaning liquid. The air pump 29 communicates with the cleaning liquid chamber 41 through an intake pipe 37. The intake pipe 37 is provided with a check valve 39. When the air pump 29 is activated, gas enters the rear side of the pressing block 40 through the intake pipe 37 to press the pressing block 40 forward to press the cleaning liquid in the cleaning liquid chamber 41. It is sprayed on the wiping portion 32 through the nozzles 43 to achieve a better cleaning effect.

The method for implementing a dust-proof computer display includes the following steps:

After the display is used, the air pump 29 starts to move the active plate 27 forward through the cylinder 28, and the gas enters the pressing block 40 through the intake pipe 37, and the pressing block 40 is pressed forward to press the cleaning liquid in the pressing block 40. The squeezing is sprayed on the wiping portion 32 through the nozzle 43, the active plate 27 pushes the upper protruding block 14 and the intermediate plate 16, and the intermediate plate 16 pushes the closing plate 33 forward to open the main chamber 11 and the sub-chamber 19. The upper protruding block 14 drives the wiping portion 32 to move forward by the fixing rod 13 and the dust removing plate 12, and moves to the plane of the rear side of the wiping portion 32 slightly lower than the plane of the screen 18, the air pump 29 stops, and the screw rod 24 rotates to drive the guiding block 25 Performing translation, because the wiping portion 32 is elastic material can reach the screen 18 position to fully fit the screen 18 for dust removal, the dust removing plate 12 simultaneously pulls the dust cloth 36 during the movement;

After the wiping and dusting is completed, the dust removing plate 12 moves to the position of the sub-chamber 19, at which time the air pump 29 performs deflation, the cylinder 28 is reset, the dust removing plate 12 is housed in the sub-chamber 19, and the closing plate 33 is reset, at which time the dust cloth 36 will The screen 18 is closed to prevent dust from accumulating;

When the cleaning liquid in the cleaning liquid chamber 41 is insufficient, the liquid storage tank 44 can be removed from the air inlet tube 37, and the filling valve 42 can be filled, and the pressing block 40 is reset by the spring 38.

In summary, the present invention has a simple structure and is easy to use. After the display is used, the present invention can automatically wipe the screen to remove dust on the screen. After the wiping is completed, the screen is closed by a dust cloth. It prevents image display distortion caused by dust accumulation when the display is not in use, which greatly improves work efficiency.

The above is only the specific embodiment of the invention, but the scope of the invention is not limited thereto, and any changes or substitutions that are not thought of by the creative work are included in the scope of the invention. Therefore, the scope of protection of the invention should be determined by the scope of protection defined by the claims.

1. A dust-proof computer display comprising a display and a screen disposed on the display, the display having a bracket on a lower side thereof, wherein the display is provided with a main cavity opening to the front, the main cavity top An upper sliding slot is disposed in the wall, an upper protruding block is slidably disposed in the upper sliding slot, a bottom sliding wall is disposed on the bottom wall of the main cavity, and a guiding block is slidably disposed in the sliding groove, and the upper end surface of the guiding block is a guiding groove is provided, the bottom wall of the main cavity is provided with a through groove communicating with the guiding groove, a sliding protrusion is arranged in the guiding groove, and the lower protruding block is a left end of the guide groove is connected by a return spring, and a screw rod is arranged between the left and right walls of the sliding groove, and the screw rod penetrates through the guide block and is threadedly engaged with the guide block. A fixing rod is fixedly disposed between the end surface and the upper end surface of the lower protruding block, and the dust removing plate is fixedly disposed on the fixing rod, and the rear end surface of the dust removing plate is fixedly provided with a wiping portion, and the wiping portion is an elastic material. The sliding slot is provided with an active contact with the rear end surface of the upper protruding block. After the use of the display is finished, the active plate moves forwardly through the upper protruding block, the fixing rod drives the dust removing plate to protrude forwardly beyond the front end opening of the main cavity, and the wiping portion is The rear end surface is located at a rear side of the front end surface of the screen, and the screw rod rotates to drive the guiding block to perform translation. Since the wiping portion is elastic material, the screen can be fully fitted to the screen when the screen position is reached. Dust removal.

2. The dust-proof computer display according to claim 1, wherein the display is provided with a sub-cavity, the dust-removing plate is movable into the sub-cavity, and the upper and lower walls of the main cavity are rotated. a rotating shaft is disposed on the rotating shaft, and one end of the dustproof cloth is fixedly connected to the left end surface of the dust removing plate, and a torsion spring is connected between the rotating shaft and the top wall of the main cavity. The dust-proof bounce moves the screen to be dust-tight when the dust-removing plate moves into the sub-cavity.

3. The dust-proof computer display according to claim 1, wherein the rear wall of the main cavity is fixedly provided with an air pump, the front end of the air pump is provided with a cylinder, and the front end of the cylinder is connected with the rear end surface of the active plate. a motor is disposed in the right wall of the sliding groove, and the motor is dynamically connected to the screw rod. The display is provided with a vertically symmetrical storage cavity, and the storage cavity is slidably provided with an intermediate plate, and the upper side is middle The lower end surface of the plate is connected to the active plate, and the front end surface of the upper and lower intermediate plates is fixedly connected with a closing plate, and the closing plate on the left side closes the main cavity, and the closing plate on the right side is the auxiliary cavity Closed.

4. The dust-proof computer display according to claim 1, wherein the rear wall of the main chamber is provided with a liquid storage tank, and the liquid storage tank is provided with a cleaning liquid chamber, and the inner wall of the cleaning liquid chamber is provided a liquid filling valve is provided, and an outer surface of the liquid storage tank is fixedly provided with a nozzle communicating with the cleaning liquid chamber, and a sliding block is arranged in the cleaning liquid chamber, and the rear end surface of the pressing block and the cleaning liquid a swing is connected between the rear wall of the cavity, the cleaning liquid chamber is filled with a cleaning liquid, and the air pump is communicated with the cleaning liquid chamber through an intake pipe, and the air inlet pipe is provided with a check valve, when the air pump is started At the same time, the gas enters the rear side of the pressing block through the intake pipe to press the pressing block forward to press the cleaning liquid in the cleaning liquid chamber to spray on the wiping portion through the nozzle. To achieve a better cleaning effect.
